(19) United States
(12) Patent Application Publication
(10) Pub. No.: US 2026/0305524 A1
(43) Pub. Date: Oct. 8, 2026

(54) METHOD FOR REDUCING NITROGEN AND PHOSPHORUS EMISSION IN STRAWBERRY CULTIVATION TO MITIGATE CONTINUOUS CROPPING OBSTACLES IN GREENHOUSE

(71) Applicant: Shandong Academy of Agricultural Sciences, Jinan (CN)

(72) Inventors: Luji BO, Jinan (CN); Kai ZHANG, Jinan (CN); Zhaozhen LUO, Jinan (CN); Xiufeng ZUO, Jinan (CN); Hongxiao LIU, Jinan (CN); Yan LI, Jinan (CN); Jiachao ZANG, Jinan (CN); Xiao YAN, Jinan (CN); Gang DUAN, Jinan (CN); Ziwen ZHONG, Jinan (CN)

(73) Assignee: Shandong Academy of Agricultural Sciences, Jinan (CN)

(21) Appl. No.: 19/409,904

(22) Filed: Dec. 5, 2025

(30) Foreign Application Priority Data
Apr. 7, 2025 (CN) 2025104249562

(51) Int. Cl. A01C 21/00; A01C 1/08; A01C 23/04; A01G 22/05; A01N 63/38; A01P 1/00; C05B 7/00; C05B 17/00; C05D 1/00; C05D 9/02; C05F 3/00; C05F 5/00; C05F 11/08; C05G 1/00; C05G 5/23

(52) U.S. Cl. CPC A01C 21/002; A01C 1/08; A01C 23/042; A01G 22/05; A01N 63/38; A01P 1/00; C05B 7/00; C05B 17/00; C05D 1/00; C05D 9/02; C05F 3/00; C05F 5/002; C05F 11/08; C05G 1/00; C05G 5/23

(57) ABSTRACT

Provided is a method for reducing nitrogen and phosphorus emissions in strawberry cultivation to mitigate continuous cropping obstacles in greenhouses, which includes: S1, after the current season's strawberries are harvested and before the next season's strawberries are planted, applying a biological disinfectant and a nutrient agent to the soil and cover with a film for high-temperature sterilization; and S2, after planting two seasons of strawberries, plowing dead branches and leaves into the soil, applying a soil conditioner, covering the soil with the film, applying base fertilizer after removing the film, sowing green manure seeds, and plowing the green manure into the soil, applying a composting agent, covering with a film to allow to ferment. The present disclosure involves addressing the core shortcomings of the prior art such as environmental pollution, nutrient inefficiency, and soil degradation, through a four-in-one technical system of “biological control, organic recycling, structural improvement, and precision management”.

### CROSS-REFERENCE TO RELATED APPLICATIONS

The application claims priority to Chinese patent application No. 2025104249562, filed on Apr. 7, 2025, the entire contents of which are incorporated herein by reference.

### TECHNICAL FIELD

The present disclosure relates to the technical field of strawberry cultivation, and in particular, to a method for reducing nitrogen and phosphorus emissions in strawberry cultivation to mitigate continuous cropping obstacles in greenhouses.

### BACKGROUND

Strawberry continuous cropping obstacle is a soil environment deterioration problem caused by continuous planting of multiple strawberry crops. It is mainly manifested in the high incidence of soil-borne diseases. Pathogens such as Fusarium and Phytophthora accumulate with the increase of continuous cropping years, leading to frequent outbreaks of diseases such as root rot and Verticillium wilt. The soil nutrient imbalance occurs and strawberries absorb nitrogen, phosphorus, and potassium selectively. After continuous cropping, the content of available phosphorus and potassium in the soil decreases significantly, while residual nitrogen is easily leached and pollutes water bodies. The soil's physical and chemical properties deteriorate, with reduced organic matter content, increased compaction, pH acidification, and weakened water and fertilizer retention capacity. The accumulation of toxic substances and the phenolic acids secreted by strawberry roots inhibit their own growth, forming a vicious cycle of continuous cropping obstacle.

Presently, measures such as chemical disinfection, crop rotation, increased application of chemical fertilizers, and physical improvement are commonly used to overcome the obstacles of continuous cropping of strawberries. However, these methods still have technical defects. Among chemical disinfection methods, fumigants such as methyl bromide and chloropicrin are often used to kill pathogens. Although they take effect quickly and have a good killing effect, they cause serious harm to humans and the environment, and also kill beneficial microorganisms in the soil indiscriminately, leading to soil microecological imbalance and reducing the disease resistance of strawberry plants. Crop rotation often involves rotating with non-solanaceous crops to alleviate the obstacle. Although this method can effectively overcome continuous cropping obstacles, rotation may prevent the planting of more economically profitable crops in the short term, thus affecting income. Furthermore, crop rotation requires a planting plan tailored to the growth cycle of different crops, demanding higher standards for planting management. Increased fertilizer application often involves applying large amounts of compound fertilizer to supplement nutrients, which will exacerbate soil acidification and nitrogen and phosphorus loss. Physical improvement methods often use high-temperature steam disinfection or deep plowing and sun-drying, which are not only energy-intensive but also lack long-lasting effects.

### SUMMARY

In order to solve the aforementioned problems, the present disclosure provides a method for reducing nitrogen and phosphorus emissions in strawberry cultivation to mitigate continuous cropping obstacles in greenhouses, specially including the following steps:
S1: when planting two consecutive seasons of strawberries, after the current season's strawberries are harvested and before the next season's strawberries are planted, applying 10-15 kg/mu of a biological disinfectant and 25-30 kg/mu of a nutrient solution to the soil and covering with a film, maintaining a temperature under the film at 50-60° C. for more than 7 days before preparing to transplant the next season's strawberry seedlings; and
S2, after planting two consecutive seasons of strawberries, plowing dead branches and leaves into the soil with a plowing depth of 15-25 cm; applying a soil conditioner at a rate of 50-80 kg/mu during plowing, covering the soil with the film for 10-15 days, applying base fertilizer at a rate of 100-200 kg/mu after removing the film, ridging, sowing green manure seeds at a rate of 4-6 kg/mu with a row spacing of 15-25 cm; applying topdressing fertilizer at a rate of 4-6 kg/mu 20 days after the green manure seedlings emerge; when the green manure plants reach a height of 40-50 cm, plowing the soil to a depth of 20-30 cm, applying a composting agent at a rate of 10-15 kg/mu and covering with a film to allow to ferment for 10-15 days; after removing the film, preparing to transplant the next season's strawberry seedlings.

Preferably, strawberry seeds are soaked in a disinfectant for 10-15 minutes before seedling cultivation, then washed with clean water to remove any residual liquid, and then soaked in a seed-promoting agent until a white sprouting rate is more than or equal to 90% before sowing.

Preferably, the mass ratio of the seeds, the disinfectant, and the seed-promoting agent is 1:4:4.

Preferably, the disinfectant is an ethanol solution with a volume fraction of 30%-50% or a sodium hypochlorite solution with a mass fraction of 0.3%-0.5%, and the seed-promoting agent includes gibberellin, chitosan, citric acid, sodium carboxymethyl cellulose and water in a mass ratio of 0.5:1:2:2:1000.

Preferably, the strawberry seedling transplanting rate is 2,400-2,600 plants per mu.

Preferably, 100-150 kg/mu of base fertilizer is applied 5-7 days before transplanting strawberry seedlings; 4-6 kg/mu of water-soluble compound fertilizer is drip-irrigated during the flower bud differentiation period; foliar fertilizer is applied at a rate of 40-60 L/mu during the fruit enlargement period, once a week for three consecutive weeks. Most preferably, the base fertilizer includes decomposed straw, decomposed manure, rice husk powder, and NPK 15-5-20 compound fertilizer in a mass ratio of 3:5:1:1. Most preferably, the decomposed straw is one or more of decomposed corn straw, decomposed rice straw, and decomposed wheat straw, and the decomposed manure is one or more of decomposed sheep manure, decomposed cow manure, decomposed pig manure, and decomposed chicken manure. The water-soluble compound fertilizer contains N, P₂O₅ and K₂O in a ratio of 5:10:40, and the foliar fertilizer includes potassium dihydrogen phosphate, borax, and water in a mass ratio of 3:1:1000.

Preferably, the biological disinfectant in the S1 includes Trichoderma harzianum powder, Paecilomyces lilacinus powder, and water in a mass ratio of 1:2:50.

Preferably, the nutrient agent in the S1 includes rice bran and molasses in a mass ratio of 4:1.

Preferably, the soil conditioner in the S2 includes activated carbon, coconut coir, vermiculite, quartz sand, quicklime, and humus in a mass ratio of 10:2:4:3:4:20.

Preferably, the green manure in the S2 is one or more of alfalfa, ryegrass, milkvetch, and sesbania.

Preferably, in the S2, the topdressing fertilizer is urea, and the composting agent includes EM inoculant, Bacillus subtilis powder, glucose and water in a ratio of 1:3:10:300.

The present disclosure has the following advantages:

(1) Trichoderma harzianum and Paecilomyces lilacinus are used as biological disinfectants to selectively inhibit pathogens and retain beneficial bacteria, which avoids the negative impact of chemical fumigants on the environment and human body.

(2) Decomposed organic materials such as straw and manure and compound fertilizer are used as the base fertilizer, avoiding the problems of eutrophication, soil compaction and acidification caused by traditional base fertilizers which are primarily composed of single chemical fertilizers. According to the present disclosure, low-nitrogen, high-potassium water-soluble fertilizer is drip-irrigated during the flower bud differentiation period, resulting in rapid nutrient release, high fertilizer utilization, and reduced nutrient waste. The present disclosure also involves planting green manure plants, which, after being plowed and compacted, are combined with a composting agent to accelerate the decomposition of organic matters, release slow-release nutrients, reduce reliance on chemical fertilizers, and dectrease the nitrogen and phosphorus emissions.

(3) According to the present disclosure, activated carbon, coconut coir and vermiculite are used as soil conditioners; by combination with high-temperature composting, the decomposition of dead branches and leaves are accelerated, the water retention, air permeability and pH value are synergistically improved, and the organic matter content in the soil is increased, solving the problem that deep plowing or adding inorganic soil conditioner only improves air permeability in the short term but cannot increase the organic matter content with a poor long-term effect.

(4) According to the present disclosure, ethanol or sodium hypochlorite is used for disinfection, and then the gibberellin-chitosan composite seed-promoting agent is used to enhance the stress resistance of strawberries, which solves the problems of low germination rate, poor disease resistance and susceptibility to disease in the seedling stage caused by single disinfection or single seed-promoting methods in the prior art.

### DETAILED DESCRIPTION OF THE EMBODIMENTS

The technical solutions in the embodiments of the present disclosure are clearly and completely described below. Apparently, the described embodiments are only a part of embodiments of the present disclosure, and are not all of embodiments thereof. All other embodiments obtained by persons of ordinary skill in the art based on the embodiments of the present disclosure without creative efforts shall fall within the protection scope of the present disclosure.

A local farm is selected to implement the following examples and comparative examples.

The microbial agents purchased in the following examples and comparative examples are provided in the table below.

| | |
|---|---|
| Trichoderma harzianum | Zhejiang Yicun Biotechnology Co., Ltd. |
| powder | |
| Paecilomyces lilacinus | Shandong Degang Biotechnology Co., Ltd. |
| powder | |
| Bacillus subtilis powder | Jiangsu Caiwei Biotechnology Co., Ltd. |
| EM inoculant | Shandong Nuojie Biotechnology Co., Ltd. |

### Example 1

At S1, when planting two consecutive seasons of strawberries, after the current season's strawberries are harvested and before the next season's strawberries are planted, apply 13 kg/mu of a biological disinfectant and 25 kg/mu of a nutrient solution to the soil and covering with a film, maintain the temperature under the film at 55° C. for more than 7 days before preparing to transplant the next season's strawberry seedlings.

The biological disinfectant included Trichoderma harzianum powder, Paecilomyces lilacinus powder, and water in a mass ratio of 1:2:50. The nutrient solution included rice bran and molasses in a mass ratio of 4:1.

At S2, after planting two consecutive seasons of strawberries, plow dead branches and leaves into the soil with a plowing depth of 20 cm; apply a soil conditioner at a rate of 65 kg/mu during plowing, cover the soil with the film for 12 days, apply base fertilizer at a rate of 150 kg/mu after removing the film, ridge, sow milkvetch at a rate of 5 kg/mu with a row spacing of 20 cm; apply urea at a rate of 5 kg/mu 20 days after seedling emergence; when the green manure plants reach a height of 45 cm, plow the soil to a depth of 25 cm, apply a composting agent at a rate of 12 kg/mu and cover with a film to allow to ferment for 13 days; after removing the film, prepare to transplant the next season's strawberry seedlings. The soil conditioner included activated carbon, coconut coir, vermiculite, quartz sand, quicklime, and humus in a mass ratio of 10:2:4:3:4:20. The composting agent included EM inoculant, Bacillus subtilis powder, glucose, and water in a ratio of 1:3:10:300.

In addition, strawberry seeds were soaked in a disinfectant for 15 minutes before seedling cultivation, then washed with clean water to remove any residual liquid, and then soaked in a seed-promoting agent until the white sprouting rate was more than or equal to 90% before sowing. The mass ratio of the seeds, the disinfectant, and the seed-promoting agent was 1:4:4. The disinfectant was an ethanol solution with a volume fraction of 40%, and the seed-promoting agent included gibberellin, chitosan, citric acid, sodium carboxymethyl cellulose, and water in a mass ratio of 0.5:1:2:2:1000.

The number of strawberry seedlings transplanted was 2,500 per mu.

Seven days before transplanting strawberry seedlings, 120 kg/mu of base fertilizer was applied; 5 kg/mu of water-soluble compound fertilizer (NPK May 10, 2040) was drip-irrigated during the flower bud differentiation period; foliar fertilizer was applied at a rate of 50 L/mu during the fruit enlargement period, once a week for three consecutive weeks. The aforementioned base fertilizer included decomposed straw, decomposed manure, rice husk powder, and NPK 15-5-20 compound fertilizer in a mass ratio of 3:5:1:1. The decomposed straw was decomposed corn straw, and the decomposed manure was decomposed sheep manure. The foliar fertilizer included potassium dihydrogen phosphate, borax, and water in a mass ratio of 3:1:1000.

In this example, except for the methods described above, other field management methods, such as strawberry seedling cultivation, strawberry water management, and strawberry pest and disease control, are referenced in High-Efficiency Cultivation of Strawberries in Greenhouses, Machinery Industry Press, edited by Lu He.

### Comparative Example 1

The difference between this comparative example and Example 1 was that the method for cultivating strawberries was entirely based on High-Efficiency Cultivation of Strawberries in Greenhouses, Machinery Industry Press, edited by Lu He.

### Test Example 1

According to the methods of Example 1 and Comparative Example 1, strawberries were planted for three years. The occurrence rate of soil-borne diseases during the planting process, as well as the soil organic matter content, single fruit weight, and soluble solids content after each strawberry harvest, were statistically analyzed and the average values of the results were calculated, as shown in Table 2. After each strawberry harvest, nitrogen fertilizer utilization rate, phosphorus fertilizer loss, and nitrogen emissions were statistically analyzed, and the average values were calculated. The results are shown in Table 2.

Nitrogen fertilizer utilization rate=(amount of nitrogen absorbed by crops/total amount of nitrogen applied)×100%. The nitrogen fertilizer application amounts for Example 1 and Comparative Example 1 were recorded. After strawberry harvest, the nitrogen content of stems, leaves, and fruits was measured, and the nitrogen fertilizer utilization rate was calculated using the formula.

Runoff collection devices were installed in the fields of Comparative Example 1 and Example 1 to monitor phosphorus loss after irrigation or rainfall.

Nitrogen emissions are the total amount of nitrogen that has not been absorbed by the crop and is emitted into the environment in gaseous (e.g., NH₃, N₂O) or liquid (e.g., NO₃⁻) form. NH₃ and N₂O emissions were determined using the static chamber method or gas sampling method; nitrate leaching was analyzed by soil solution sampling.

TABLE 2

| | Example 1 | Comparative Example 1 |
|---|---|---|
| Occurrence rate of soil-borne | ≤15 | ≥50 |
| disease (%) | | |
| Soil organic matter content | 18.6 | 9.1 |
| (g/kg) | | |
| Weight of a single fruit (g) | 27-36 | 18-22 |
| Soluble solids content (%) | 10-12 | 7-9 |
| Nitrogen fertilizer utilization | 45-50 | 30-40 |
| rate (%) | | |
| Phosphorus loss (kg/mu) | 1.2-1.5 | 3-4 |
| Nitrogen emissions (kg/mu) | 7-9 | 13-15 |

As shown in Table 2, the cultivation method of the present disclosure could significantly reduce the occurrence rate of soil-borne diseases, decrease the phosphorus loss and nitrogen emissions, and significantly improve soil organic matter content, nitrogen fertilizer utilization rate and fruit quality compared with the prior art. Therefore, the cultivation method of the present disclosure was significantly superior to the prior art.

The foregoing description of the disclosed embodiments enables those skilled in the art to implement or use the present disclosure. Various modifications to these embodiments will be readily apparent to those skilled in the art, and the general principles defined herein may be implemented in other embodiments without departing from the spirit or scope of the present disclosure. Therefore, the present disclosure is not to be limited to the embodiments shown herein, but is to be accorded the widest scope consistent with the principles and novel features disclosed herein.

What is claimed is:

1. A method for reducing nitrogen and phosphorus emissions in strawberry cultivation to mitigate continuous cropping obstacles in greenhouses, comprising the following steps:
S1: when planting two consecutive seasons of strawberries, after the current season's strawberries are harvested and before the next season's strawberries are planted, applying 10-15 kg/mu of a biological disinfectant and 25-30 kg/mu of a nutrient solution to the soil and covering with a film, maintaining a temperature under the film at 50-60° C. for more than 7 days before preparing to transplant the next season's strawberry seedlings; and
S2: after planting two consecutive seasons of strawberries, plowing dead branches and leaves into the soil, applying a soil conditioner at a rate of 50-80 kg/mu during plowing, covering the soil with the film, applying base fertilizer at a rate of 100-200 kg/mu after removing the film, ridging, sowing green manure seeds, and applying topdressing fertilizer 20 days after the green manure seedlings emerge; when the green manure plants reach a height of 40-50 cm, plowing the soil to a depth of 20-30 cm, applying a composting agent, covering with a film to allow to ferment for 10-15 days; after removing the film, preparing to transplant the next season's strawberry seedlings.

2. The method for reducing nitrogen and phosphorus emissions in strawberry cultivation to mitigate continuous cropping obstacles in greenhouses according to claim 1, wherein strawberry seeds are soaked in a disinfectant before seedling cultivation, then washed with clean water to remove any residual liquid, and then soaked in a seed-promoting agent until a white sprouting rate is more than or equal to 90% before sowing and seedling cultivation.

3. The method for reducing nitrogen and phosphorus emissions in strawberry cultivation to mitigate continuous cropping obstacles in greenhouses according to claim 2, wherein the disinfectant is an ethanol solution with a volume fraction of 30%-50% or a sodium hypochlorite solution with a mass fraction of 0.3%-0.5%.

4. The method for reducing nitrogen and phosphorus emissions in strawberry cultivation to mitigate continuous cropping obstacles in greenhouses according to claim 2, wherein the seed-promoting agent comprises gibberellin, chitosan, citric acid, sodium carboxymethyl cellulose, and water in a mass ratio of 0.5:1:2:2:1000.

5. The method for reducing nitrogen and phosphorus emissions in strawberry cultivation to mitigate continuous cropping obstacles in greenhouses according to claim 1, wherein 100-150 kg/mu of base fertilizer is applied before transplanting strawberry seedlings; 4-6 kg/mu of water-soluble compound fertilizer is drip-irrigated during the flower bud differentiation period; and foliar fertilizer is applied at a rate of 40-60 L/mu during the fruit enlargement period.

6. The method for reducing nitrogen and phosphorus emissions in strawberry cultivation to mitigate continuous cropping obstacles in greenhouses according to claim 5, wherein the water-soluble compound fertilizer contains N, P₂O₅ and K₂O in a ratio of 5:10:40, and the foliar fertilizer comprises potassium dihydrogen phosphate, borax, and water in a mass ratio of 3:1:1000.

7. The method for reducing nitrogen and phosphorus emissions in strawberry cultivation to mitigate continuous cropping obstacles in greenhouses according to claim 1, wherein the base fertilizer comprises decomposed straw, decomposed manure, rice husk powder, and NPK 15-5-20 compound fertilizer in a mass ratio of 3:5:1:1.

8. The method for reducing nitrogen and phosphorus emissions in strawberry cultivation to mitigate continuous cropping obstacles in greenhouses according to claim 1, wherein the biological disinfectant in the S1 comprises Trichoderma harzianum powder, Paecilomyces lilacinus powder, and water in a mass ratio of 1:2:50.

9. The method for reducing nitrogen and phosphorus emissions in strawberry cultivation to mitigate continuous cropping obstacles in greenhouses according to claim 1, wherein the nutrient agent in the S1 comprises rice bran and molasses in a mass ratio of 4:1.

10. The method for reducing nitrogen and phosphorus emissions in strawberry cultivation to mitigate continuous cropping obstacles in greenhouses according to claim 1, wherein the composting agent in the S2 comprises EM inoculant, Bacillus subtilis powder, glucose and water in a ratio of 1:3:10:300.
